(19) United States
(12) Patent Application Publication
(10) Pub. No.: US 2011/0290876 A1
(43) Pub. Date: Dec. 1, 2011

(54) INTEGRATED INVENTORY SCANNING AND ANALYSIS SYSTEM

(75) Inventors: Carter Graves, Dallas, TX (US); Kevin Arnold, Coppell, TX (US); Paul Billings, Dallas, TX (US)

(73) Assignee: DataScan LP, Carrollton, TX (US)

(21) Appl. No.: 12/789,054

(22) Filed: May 27, 2010

(51) Int. Cl. G06F 19/00

(52) U.S. Cl. 235/385

(57) ABSTRACT

The present disclosure generally provides an integrated system of gathering and analyzing inventory data in real-time using a hand-held scanner in communication with a network, database, and user interface. The hand-held scanner could be remotely accessed and updated using a wireless connection and thus improving efficiency and minimizing downtime. The integrated system thus allows data collected by the hand-held scanner to be queried, analyzed, and aggregated to assess various inventory related issues including, for example, inventory levels, projected sales figures, and reordering information in real-time.

The disclosure relates generally to inventory tracking systems and, in particular, to inventory scanning and analysis systems.

### BACKGROUND

Wholesalers and retailers alike typically stockpile products and arbitrarily order new inventory based on perceived consumer demand and manually calculated statistics from historical demand data. Conventional inventory systems could include barcode tracking systems or other standard marking and identification coding systems either associated with the product itself, on the packaging of product, or in a shipping or storage container having multiple products therein. In order to run businesses effectively, such entities require certain systems and procedures to track, monitor, analyze, and aggregate inventory information accurately and quickly.

What is required is a cost-effective, efficient system of gathering and analyzing inventory data in real-time.

### SUMMARY

Embodiments of the present disclosure generally provide an integrated inventory scanning and analysis system.

In one embodiment, the present disclosure could generally provide an inventory scanning and analysis system. The system could include a device having a scanner, a handle, and a trigger disposed on the handle to operate the scanner. The system could also include a communication module to wirelessly communicate data associated with inventory scanned by the device to a remote user interface.

In one embodiment, the present disclosure could generally provide an inventory scanning and analysis system. The system could include a device having a scanner, a handle, and a trigger disposed on the handle to operate the scanner. The device could be configurable using information received from a wireless network. The system could also include a communication module to communicate data in real-time between the scanning device and a graphical user interface associated with a website using the wireless network.

In one embodiment, the present disclosure could generally provide an inventory scanning and analysis system. The system could include a device having a scanner. The system could also include a screen disposed on the device to display information associated with the device. The system could further include a set of programmable actuators disposed on the device and a handle removably disposed on the device. The system could also include a trigger disposed on the handle to operate the scanner. The device could be configurable using information received from a wireless network. The system could further include a communication module to communicate data between the scanning device and a graphical user interface associated with a website using the wireless network in real-time.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1A is a somewhat simplified diagram of an exemplary integrated inventory scanning and analysis system according to one embodiment of the present disclosure;

FIG. 1B is a somewhat simplified diagram of an exemplary scanning device according to one embodiment of the present disclosure;

FIG. 2 is a somewhat simplified top plan view of an exemplary scanning device according to one embodiment of the present disclosure;

FIG. 3 is a somewhat simplified bottom plan view of the scanning device shown in FIG. 2 according to one embodiment of the present disclosure;

FIG. 4 is a somewhat simplified perspective view of the scanning device shown in FIG. 2 according to one embodiment of the present disclosure;

FIG. 5 is a somewhat simplified perspective view of the scanning device shown in FIG. 2 fitted with an exemplary extended handle and trigger apparatus according to one embodiment of the present disclosure;

FIG. 6 is a somewhat simplified bottom plan view of the scanning device shown in FIG. 5 according to one embodiment of the present disclosure;

FIG. 7 is a somewhat simplified side plan view of the scanning device shown in FIG. 5 according to one embodiment of the present disclosure;

FIG. 8 is a somewhat simplified second side plan view of the scanning device shown in FIG. 5 according to one embodiment of the present disclosure; and

FIG. 9 is a somewhat simplified perspective view of an exemplary docking station according to one embodiment of the present disclosure.

### DETAILED DESCRIPTION

The present disclosure could generally provide an integrated system of gathering and analyzing inventory data in real-time using a hand-held scanner in communication with a network, database, and user interface according to one embodiment of the present disclosure. The hand-held scanner could be remotely accessed and updated using a wireless connection and thus improving efficiency and minimizing downtime. The data collected by the hand-held scanner could be queried, analyzed, and aggregated to assess various inventory related issues including, for example, inventory levels, projected sales figures, and reordering information according to one embodiment of the present disclosure.

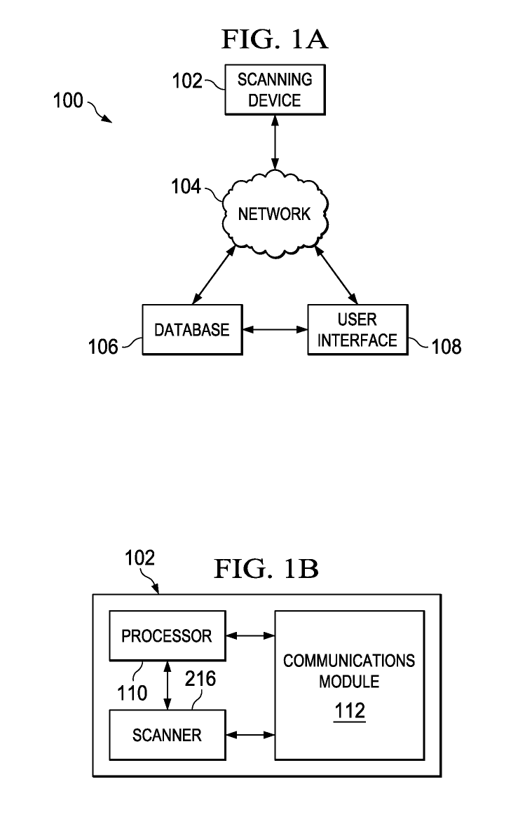

FIG. 1A is a somewhat simplified diagram of integrated inventory scanning and analysis system 100 according to one embodiment of the present disclosure. It should be understood that system 100 shown in FIG. 1A is for illustrative purposes only and that any other suitable system or subsystem could be used in conjunction with or in lieu of system 100 according to one embodiment of the present disclosure.

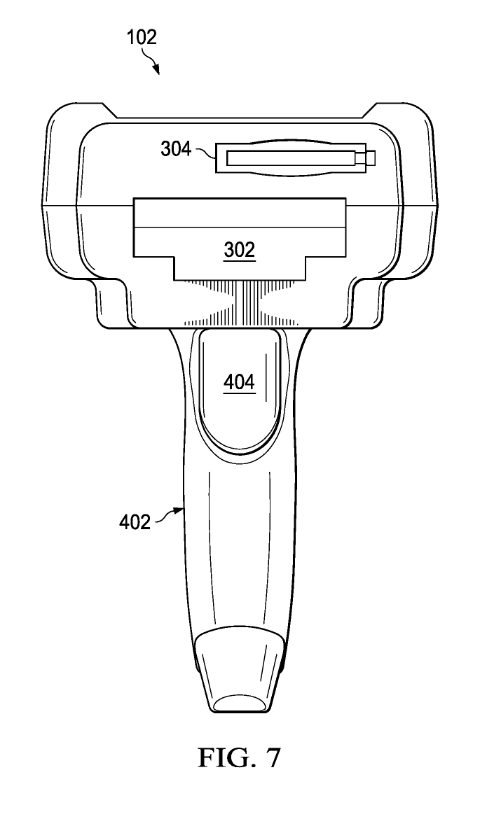

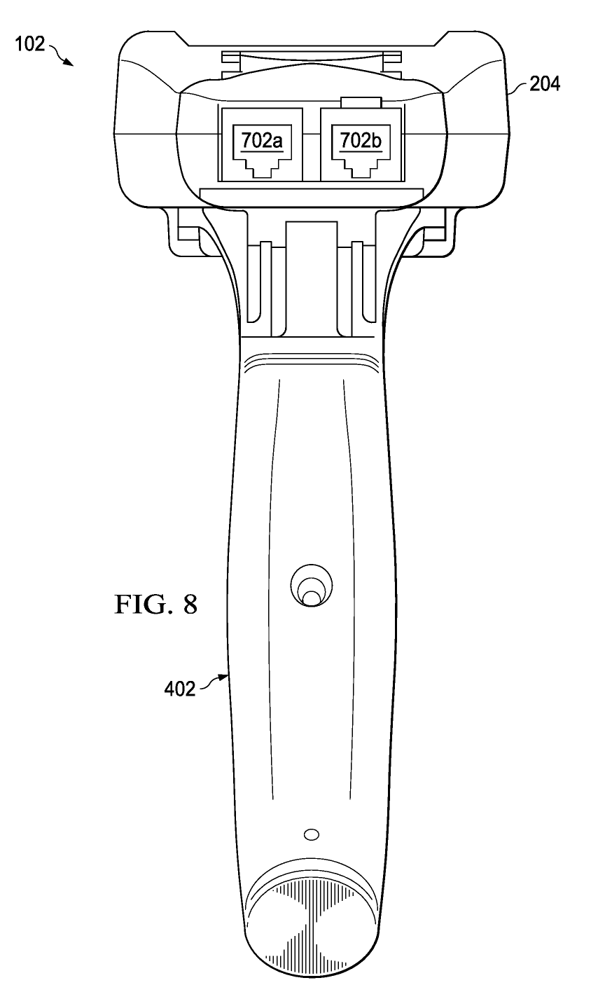

In one embodiment, system 100 could include scanning device 102, network 104, database 106, and user interface 108. Scanning device 102 could include any suitable device to scan, image, read, store, analyze, and/or process a label, bar code, data matrix, marking, or other product identifier. As an example, in one embodiment, scanning device 102 could include any of the scanning devices shown and later described in conjunction with the description accompanying FIGS. 1B-8 herein.

In one embodiment, scanning device 102 could be used generally to scan an identifier for a particular product or batch of products, temporarily store the identifier, and ultimately send information related to the identifier to a network, database, and/or user interface. For example, once scanning device 102 collects inventory data from a product, the packaging of product, or the shipping or storage container having multiple products therein, scanning device 102 could send product identifiers, quantity information, or other related data or information to network 104 according to one embodiment of the present disclosure.

In one embodiment, scanning device 102 could send the information to network 104 via a wire-line connection or a wireless connection. For example, scanning device 102 could send the information to network 104 via a dedicated or secure network connection, wire-line connection, wireless connection, Internet, Intranet, WiFi, LAN, WAN, telephone line, T1 line, cellular network, mobile phone communication network, telecommunications network, other suitable communication systems, or any combination thereof according to one embodiment of the present disclosure.

Network 104 could provide access to data collected by system 100 and communicate the data or information to database 106 and/or user interface 108 in real-time. Network 104 could include any suitable network of computers, terminals, databases, applications, programs, software, secured areas, networked devices, other suitable devices or modules, or any combination thereof configured to communicate by one or more wire-line or wireless connections.

In one embodiment, network 104 could include any suitable server, user terminal, stand-alone unit, network device, database, module, application, software, modem, cellular modem, facsimile machine, backup database, telephone system, router, Internet connection, Intranet connection, Internet portal, Intranet portal, user graphical interface, remote access portal, other suitable device, area, or database, or any combination thereof. It should be understood that network 104 could be any suitable number, size, or configuration according to one embodiment of the present disclosure.

Database 106 could include any suitable data storing or data storing and correlating unit to store, parse, categorize, or perform any other suitable function by using, for example, storage rules, product category rules, bar code rules, access rules, management information, collected data, correlated data, data, desired queries, behavioral information, other suitable information, or any combination thereof. It should be understood that any suitable number, size, or configuration of database 106 could be used according to one embodiment of the present disclosure.

User interface 108 could be accessed by an authorized person, a group of people, employee, group of employees, a system, certain security levels, or an authorized network of systems to view, correlate, analyze, and report information collected by scanning device 102 according to one embodiment of the present disclosure. User interface 108 could include a user terminal, website, stand-alone unit, network device, machine, wireless device, telephone system, smart phone, cellular modem, Internet portal, Intranet portal, remote access portal, hand-held unit, other suitable device or terminal, or any combination thereof. In one embodiment, access to one or more of scanning device 102, network 104, database 106, and user interface 108 could be restricted by certain criteria such as, for example, membership or association with particular departments, management levels, users, employees, security clearances, priority levels, biometric data, other suitable groups, or any combination thereof.

Based on the information collected, system 100 could correlate, in real-time, certain information such as, for example, existing inventories, inventories that have been purchased, best sellers in a particular group of products, exchanges/returns, sales, promotions, specials, sell by dates, origination numbers, balance information, time product has been on shelf, age of product, commissions, other suitable inventory or product related information, or any combination thereof. The collected information could be correlated, presented, stored, queried, analyzed, or aggregated in real-time, to produce predetermined reports, custom reports, aggregated data reports, data mining reports, other suitable reports or forms, or any combination thereof according to one embodiment of the present disclosure.

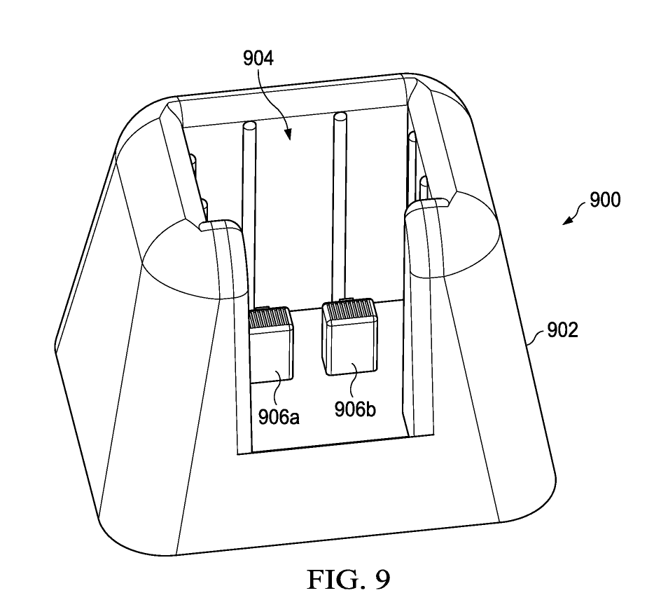

In one embodiment, scanning device 102, network 104, database 106, and user interface 108 could include certain software applications to enable or enhance its functionality or performance and such software could be updated wirelessly using the cellular data or phone network. Thus, the user of scanning device 102 need not necessarily physically place scanning device 102 in a docking station (such as docking station 900 shown and described in conjunction with FIG. 9 herein) or other location to update software on or communicate with scanning device 102 to efficiently update system 100 or parts of system 100 and minimize down-time.

In one embodiment, system 100 could disseminate a software update from the user interface 108 to scanning device 102 using wireless network 104 and deliver custom client programs with, for example, communication instructions and/or updated functional capabilities according to one embodiment of the present disclosure. In one example, software updates could be used to provide instruction, train, or otherwise provide guidance to the user of scanning device 102 on a particular inventory related task.

In one embodiment, system 100 could disseminate and send text, image, video, or voice messages in real-time to the user of scanning device 102 using network 104 according to one embodiment of the present disclosure. In this way, the personnel in a back-office or associated with a management team could communicate with a user of scanning device 102 in real-time. Similarly, the user of scanning device 102 could send text, image, video, or voice messages in real-time to user interface 108 using network 104 to communicate with the back-office or management team according to one embodiment of the present disclosure.

In one embodiment, system 100 could track an individual employee's, group of employees', or store's progress or time spent in performing or completing inventory related tasks. In this way, system 100 could be used to report and assess productivity and design future inventory related projects in an efficient manner according to one embodiment of the present disclosure.

FIG. 1B is a somewhat simplified diagram of scanning device 102 according to one embodiment of the present disclosure. It should be understood that scanning device 102 shown in FIG. 1B is for illustrative purposes only and that any other suitable system or subsystem could be used in conjunction with or in lieu of scanning device 102 according to one embodiment of the present disclosure.

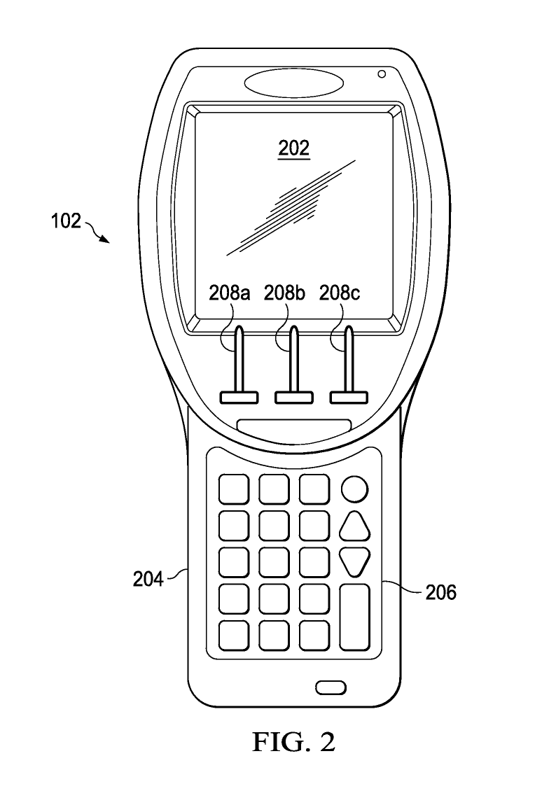

Scanning device 102 could include processor 110, communications module 112, and scanner 216 (later described in conjunction with the description accompanying FIG. 2 herein). Scanning device 102 could also include a processor to store, parse, categorize, or perform any other suitable function by using, for example, storage rules, product category rules, bar code rules, access rules, management information, collected data, correlated data, data, desired queries, behavioral information, other suitable information, or any combination thereof. It should be understood that any suitable number, size, or configuration of processor 110 could be used according to one embodiment of the present disclosure.

Communication module 112 could be used to facilitate communications between scanning device 102 and any suitable network, server, user terminal, stand-alone unit, network device, database, module, application, software, modem, cellular modem, facsimile machine, backup database, telephone system, router, Internet connection, Intranet connection, Internet portal, Intranet portal, user graphical interface, remote access portal, other suitable device, area, or database, or any combination thereof.

In one embodiment, communication module 112 or any other suitable part of scanning device 102 could include a unique identifier that could be used to identify a particular scanning device 102 or group of scanning devices 102. In this way, should a particular scanning device require a software update, system 100 could easily identify and communicate with that particular scanning device. Similarly, if a new scanning device 102 needs provisioning or initialization software, system 100 could provide the same once scanning device 102 is properly identified.

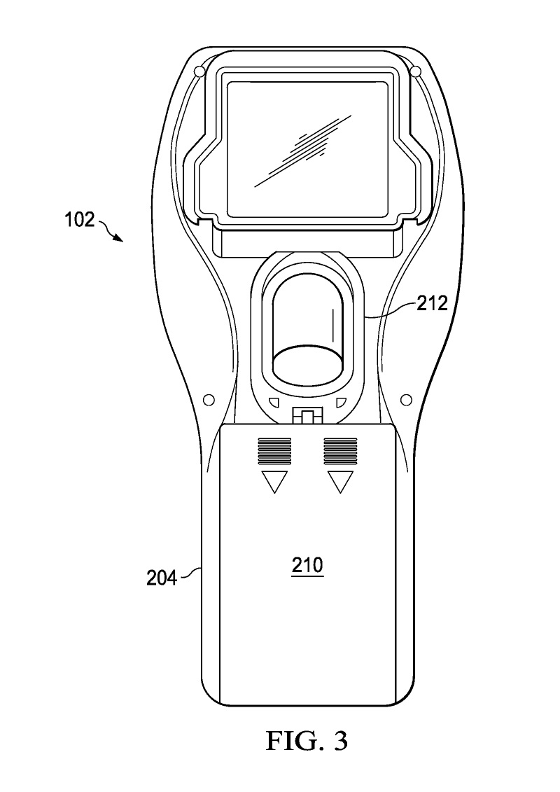

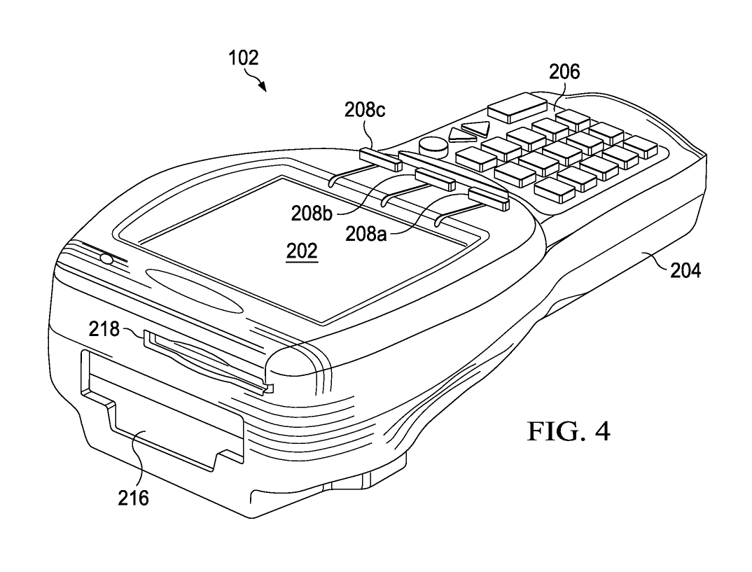

FIGS. 2 and 3 are somewhat simplified top plan and bottom plan views, respectively, of scanning device 102 according to one embodiment of the present disclosure, while FIG. 4 is a somewhat simplified perspective view of scanning device 102 according to one embodiment of the present disclosure. It should be understood that scanning device 102 shown in FIGS. 2, 3, and 4 are for illustrative purposes only and that any other suitable system or subsystem could be used in conjunction with or in lieu of scanning device 102 according to one embodiment of the present disclosure.

Scanning device 102 could include screen 202, handle area 204, keypad 206, soft keys 208a, 208b, and 208c (collectively referred to herein as soft keys 208), battery compartment 210, adapter 212, scanner 216, and card input 218 as shown in FIGS. 2, 3, and 4 according to one embodiment of present disclosure. It should be understood, however, that scanning device 102 could include any number of suitable accessories or features such as, for example, a handle, ergonomic features, gripping pads or surfaces, other suitable features and accessories, or any combination thereof.

Screen 202 could be used to display any suitable information to the user of scanning device 102 according to one embodiment of the present disclosure. Screen 202 could include any suitable display device such as, for example, cathode ray tube (CRT) screen, liquid crystal display (LCD) screen, active matrix display screen, thin film transistor (TFT) screen, plasma screen, touch screen, thermo-sensitive screens, any other suitable screen or display, or any combination thereof. In one embodiment, screen 202 could be coated or include a protective film to reduce glare or prevent scratches.

Handle area 204 could be used to hold, manipulate, handle, or otherwise secure scanning device 102 according to one embodiment of the present disclosure. Handle area 204 and the housing of scanning device 102 could be made of light-weight, durable material and include one or more suitable materials including, for example, plastic, synthetic rubber, natural rubber, silicone, nylon, polypropylene, polyurethane, polyethylene, polyvinyl chloride (PVC), polytetrafluoroethylene (PTFE), polyester, high-gloss polyester, plastic, metal, glass, polymer, other suitable materials, or any combination thereof.

Keypad 206 and/or soft keys 208 could be used by a user of scanning device 102 to manually input data or select certain functions for scanning device 102 according to one embodiment of the present disclosure. Keypad 206 and/or soft keys 208 could include a standard set of keys or be customized by hardware and/or software changes by the end user, customer, manufacturer, or user interface 108 as desired.

In one embodiment, keypad 206/soft keys 208 could be used to drive and/or select a menu-driven window displayed on screen 202. Keypad 206/soft keys 208 could also be used to input data related to passwords, user verification, customer number, store identification, employee information, location information, store aisle or shelf information, quantity information, other suitable inventory related information, or any combination thereof. It should be understood, however, that although keypad 206/soft keys 208 are illustrated as generally including a set of different shaped and sized “keys”, any suitable number, size, shape, and configuration of keys, buttons, dials, touch pads, temperature sensitive devices, pressure sensitive devices, sensors, actuators, or other actuating devices could be used according to one embodiment of the present disclosure.

Battery compartment 210 could be used to access a battery (not shown in FIGS. 1A-9) to power scanning device 102 according to one embodiment of the present disclosure. Battery compartment 210 could house one or more, for example, rechargeable batteries, non-rechargeable batteries, nickel cadmium batteries, nickel metal hydride, lithium ion, fuel cell batteries, solar batteries, kinetic batteries, any other suitable power source or battery, or any combination thereof. In one embodiment, scanning device 102 could be run on one of multiple power saving modes to save battery life. It should be understood, however, that scanning device 102 could also include an AC power adapter and be powered using AC power according to one embodiment of the present disclosure.

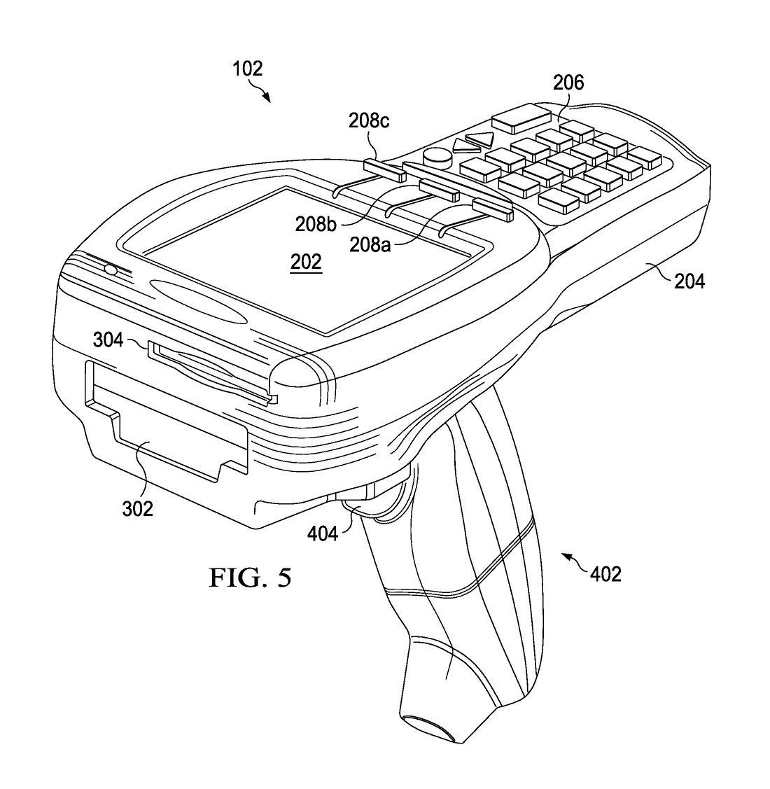

Adapter 212 could be used to secure or otherwise retain handle 402 as shown and later described in conjunction with the description accompanying FIGS. 5-8 herein according to one embodiment of the present disclosure. In one embodiment, adapter 212 could include any suitable retaining system including those having, for example, a quick release connector, a thread lock, a snap lock, a snap fitting, a clasp, a magnetic coupling, rotator couplings, groove, any suitable coupling or locking device or system, or any combination thereof.

Scanner 216 could be used to perform the scanning or reading function of scanning device 102 according to one embodiment of the present disclosure. Scanner 216 could include any suitable magnetic or photo-electric source to scan or read images such as, for example, bar codes, data matrix codes, and product identifiers, from a product, the packaging of the product, or from a shipping or storage container having multiple products therein.

In one embodiment, scanner 216 could include a verification mechanism that confirms when a particular inventory identifier has been scanned correctly. For example, once scanner 216 has confirmed that an inventory identifier has been scanned correctly, scanner 216 could provide an audible indication such as a beep, alarm, or computerized voice confirmation. Scanner 216 could be configured to provide visual confirmation using a light or series of lights according to one embodiment of the present disclosure.

In one embodiment, after scanner 216 successfully scans an inventory identifier of a particular product, the packaging of a product, or a shipping or storage container having multiple products therein, the inventory identifier could be flagged with an additional identifier so that subsequent scans of the same inventory identifier would be blocked or otherwise flagged as “previously scanned.” Such additional identifiers could be activated temporarily for a particular time period, inventory period, or be permanent linked therewith.

In one embodiment, scanner 216 could convert the bar codes, data matrix codes, product identifier, or other images into electrical signals. The electrical signals could then be processed by scanning device 102, network 104, database 106, and/or user interface 108 and possibly converted into data, series of data, encrypted data, information, colored or black and white texts, graphics, and pictures. In one embodiment, the data could be encrypted or otherwise embedded with a security feature before being transmitted to network 104, database 106, or user interface 108 by scanning device 102.

Card input 218 could be used to connect or otherwise communicate with any suitable input card to scanning device 102 such as for example, a memory stick/device, a storage device, magnetic disk, optical disk, USB drive, video card, sound card, other suitable device, or any combination thereof according to one embodiment of the present disclosure.

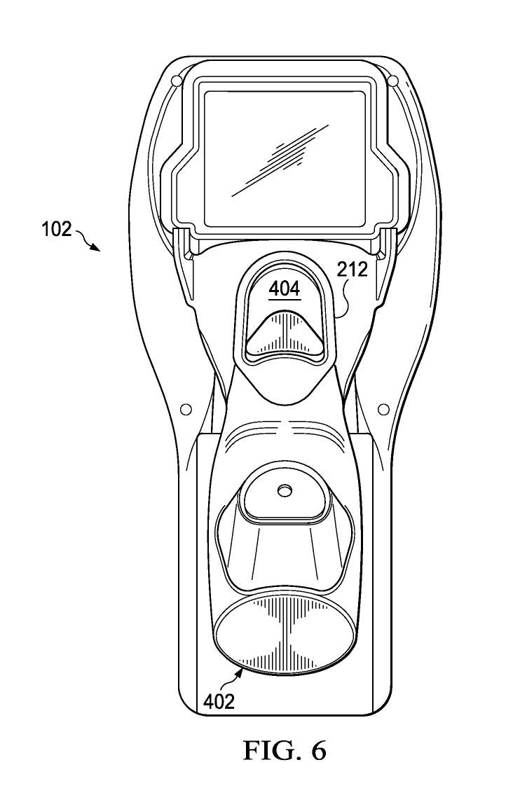

FIG. 5 is a somewhat simplified perspective view of scanning device 102 shown in FIGS. 1A-4 fitted with extended handle 402 and trigger apparatus 404 according to one embodiment of the present disclosure. FIGS. 6-8 are somewhat simplified bottom and side plan views of the scanning device shown in FIG. 5 according to one embodiment of the present disclosure. It should be understood that scanning device 102, extended handle 402, and trigger apparatus 404 shown in FIGS. 5-8 are for illustrative purposes only and that any other suitable system or subsystem could be used in conjunction with or in lieu of scanning device 102, extended handle 402, and/or trigger apparatus 404 according to one embodiment of the present disclosure.

Extended handle 402 could be used to hold, manipulate, handle, or otherwise secure scanning device 102 according to one embodiment of the present disclosure. Extended handle 402 could be made of one or more suitable materials including, for example, plastic, synthetic rubber, natural rubber, silicone, nylon, polypropylene, polyurethane, polyethylene, polyvinyl chloride (PVC), polytetrafluoroethylene (PTFE), polyester, high-gloss polyester, plastic, metal, glass, polymer, other suitable materials, or any combination thereof.

It should be understood that extended handle 402 could include any number of suitable accessories or features such as, for example, a handle, ergonomic features, gripping pads or surfaces, head phone jacks, other suitable features and accessories, or any combination thereof. In addition, although handle 402 shown in FIGS. 5-8 illustrates one embodiment of handle 402, it should be understood that extended handle 402 could include any suitable size, shape, or configuration according to one embodiment of the present disclosure.

Trigger apparatus 404 could be used to activate scanner 216 according to one embodiment of the present disclosure. For example, by actuating trigger apparatus 404, the user of scanning device 102 could activate scanner 216, which in turn could convert bar codes, data matrix codes, product identifiers, or other images into electrical signals. In one embodiment, trigger apparatus 404 could include any actuator such as, for example, a single action trigger, a double action trigger, a push button, a switch, a remote triggering device, a dial, a lever, a key, other suitable actuating device, or any combination thereof.

Trigger apparatus 404 could also include a mechanism to aid in preventing multiple triggers within a short time period to avoid incorrectly scanning the same product identifier twice in a row. It should also be understood that when extended handle 402 or trigger apparatus 404 is not installed on scanning device 102, any key or other actuator on scanning device 102 could be programmed to function in a similar manner to trigger apparatus 404.

FIG. 9 is a somewhat simplified perspective view of docking station 900 according to one embodiment of the present disclosure. It should be understood that docking station 900 shown in FIG. 9 is for illustrative purposes only and that any other suitable system or subsystem could be used in conjunction with or in lieu of docking station 900 according to one embodiment of the present disclosure.

Docking station 900 could include connections or a port replicator to provide a relatively simplified method of “plugging-in” scanning device 102 according to one embodiment of the present disclosure. In one embodiment, docking station 900 could include a base 902, docking area 904, and connections 906a and 906b. Docking station 900 could aid in connecting (using connections 906a and/or 906b) to power sources, data lines, electronic devices, communication portals, Internet connection, Ethernet, cellular networks, telephone line, laptop computer, printer, storage device, other common peripherals or sources, or any combination thereof. Docking station 900 and base 902 could be suitably sized and shape to accommodate handle area 204 or any other suitable connection to scanning device 102 in docking area 904.

System 100 thus generally provides an integrated system of gathering and analyzing inventory data in real-time using a hand-held scanner in communication with a network, database, and user interface according to one embodiment of the present disclosure. The hand-held scanner could be remotely accessed and updated using a wireless connection and thus improving efficiency and minimizing downtime. System 100 thus allows data collected by the hand-held scanner to be queried, analyzed, and aggregated to assess various inventory related issues including, for example, inventory levels, projected sales figures, and reordering information in real-time according to one embodiment of the present disclosure.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The term “real-time” refers to system that generally updates information at the same rate it receives the information.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An inventory scanning and analysis system comprising:
a device having a scanner, a handle, and a trigger disposed on the handle to operate the scanner; and
a communication module to wirelessly communicate data associated with inventory scanned by the device to a remote user interface.

2. The system of claim 1, wherein the scanner comprises a photo-electric source to scan images proximate to the device.

3. The system of claim 1 further comprising:
a screen to display information associated with the device.

4. The system of claim 1, wherein the communication module wirelessly communicates data from the device to a cellular network in real-time.

5. The system of claim 1, wherein the communication module is configured to receive data from a cellular network.

6. The system of claim 1, wherein the removable handle comprises a quick-release connection to connect the handle to the housing of the device.

7. The system of claim 1 further comprising:
an actuator disposed on the device, wherein the function of the actuator is programmable.

8. The system of claim 1, wherein the device is configurable using software received from a cellular network.

9. The system of claim 1, wherein the remote user interface comprises a graphical user interface associated with a website.

10. An inventory scanning and analysis system comprising:
a device having a scanner, a handle, and a trigger disposed on the handle to operate the scanner, wherein the device is configurable using information received from a wireless network; and
a communication module to communicate data in real-time between the scanning device and a graphical user interface associated with a website using the wireless network.

11. The system of claim 10, wherein the scanner comprises a photo-electric source to scan images proximate to the device.

12. The system of claim 10 further comprising:
a screen to display information associated with the device.

13. The system of claim 10, wherein the wireless network comprises a cellular network.

14. The system of claim 10, wherein the removable handle comprises a quick-release connection to connect the handle to the housing of the device.

15. The system of claim 10 further comprising:
a set of programmable actuators disposed on the device.

16. The system of claim 10, wherein the data comprises information associated with inventory scanned by the device.

17. An inventory scanning and analysis system comprising:
a device having a scanner;
a screen disposed on the device to display information associated with the device;
a set of programmable actuators disposed on the device;
a handle removably disposed on the device;
a trigger disposed on the handle to operate the scanner, wherein the device is configurable using information received from a wireless network; and
a communication module to communicate data between the scanning device and a graphical user interface associated with a website using the wireless network in real-time.

18. The system of claim 17, wherein the scanner comprises a photo-electric source to scan images proximate to the device.

19. The system of claim 17, wherein the wireless network comprises a wireless cellular network.

20. The system of claim 17, wherein the data comprises information associated with inventory scanned by the device.
